(19) United States
(12) Patent Application Publication
(10) Pub. No.: US 2014/0130596 A1
(43) Pub. Date: May 15, 2014

(54) ANGULAR VELOCITY DETECTION DEVICE

(71) Applicant: Hitachi Automotive Systems, Ltd., Ibaraki (JP)

(72) Inventors: Toshiaki Nakamura, Tokyo (JP); Masahiro Matsumoto, Tokyo (JP); Hiroshi Iwasawa, Tokyo (JP); Satoshi Asano, Tokyo (JP); Masahide Hayashi, Hitachinaka (JP)

(73) Assignee: Hitachi Automotive Systems, Ltd., Ibaraki (JP)

(21) Appl. No.: 14/129,054

(22) PCT Filed: Jun. 20, 2012
(86) PCT No.: PCT/JP2012/065685

§ 371 Date: Dec. 23, 2013

(30) Foreign Application Priority Data
Jun. 30, 2011 (JP) 2011-145158

(51) Int. Cl. G01P 3/42

(52) U.S. Cl. CPC G01P 3/42
USPC 73/504.12

(57) ABSTRACT

The purpose of the present invention is to achieve accurate angular velocity detection even when an angular velocity detection sensor is set in an environment in which oscillation and electromagnetic noise have significant influence. Provided is an angular velocity detection device which has an oscillating body displaceable in first and second directions that are perpendicular to each other, and which detects, as an angular velocity, a displacement of the oscillating body in the second direction while the oscillating body is being oscillated in the first direction, wherein in accordance with a frequency change in a drive signal for oscillating the oscillating body in the first direction, the frequency of a servo signal for detecting the angular velocity from the quantity of displacement in the second direction is changed (see FIG. 1).

### TECHNICAL FIELD

The present invention relates to an oscillation-type angular velocity sensor. More specifically, the present invention relates to an angular velocity sensor that reduces influences of change in resonance frequency of displacement signal of oscillating body.

### BACKGROUND ART

Patent Literatures 1, 2, and 3 listed below, for example, disclose devices regarding methods for controlling oscillating-type angular velocity sensors with high precision.

### CITATION LIST

### Patent Literature

Patent Literature 1: JP Patent No. 3729191

Patent Literature 2: JP Patent Publication (Kokai) No. 2000-105125 A

Patent Literature 3: JP Patent Publication (Kokai) No. H08-007070 A (1996)

### SUMMARY OF INVENTION

### Technical Problem

In an antiskid brake system for securing safety of running automobiles, it is required to keep the precision of sensors detecting angular velocities caused by skids or turnings on compacted snow roads or frozen roads at high level. In terms of such technical problems, Patent Literature 1 discloses an example where angular velocities are detected by servo-control. Patent Literature 2 discloses an example where an oscillating body is driven at a resonant frequency by frequency adjusting control. Patent Literature 3 discloses an example where sensor data for multiple cycles is sampled to perform digital control.

However, if an angular velocity sensor is placed in an environment, such as an engine room, where the temperature varies within wide range and vibration or electromagnetic noise has significant effects, further techniques are required for keeping precision of sensors in addition to the techniques mentioned above.

An objective of the present invention is to achieve angular velocity detection with high precision even if the angular velocity detection sensor is placed in an environment where vibration or electromagnetic noise has significant effects.

### Solution to Problem

The angular velocity detection device according to the present invention comprises an oscillating body displaceable in a first and a second direction perpendicular to each other, the angular velocity detection device detecting, as an angular velocity, a displacement of the oscillating body in the second direction when the oscillating body is oscillating in the first direction, wherein the angular velocity detection device changes a frequency of a servo signal for detecting an angular velocity based on a displacement amount of the oscillating body in the second direction in accordance with a change in frequency of a drive signal that oscillates the oscillating body in the first direction.

### Advantageous Effects of Invention

With an angular velocity detection device according to the present invention, angular velocity detection with high precision is achieved even if the angular velocity detection sensor is placed in an environment where vibration or electromagnetic noise has significant effects.

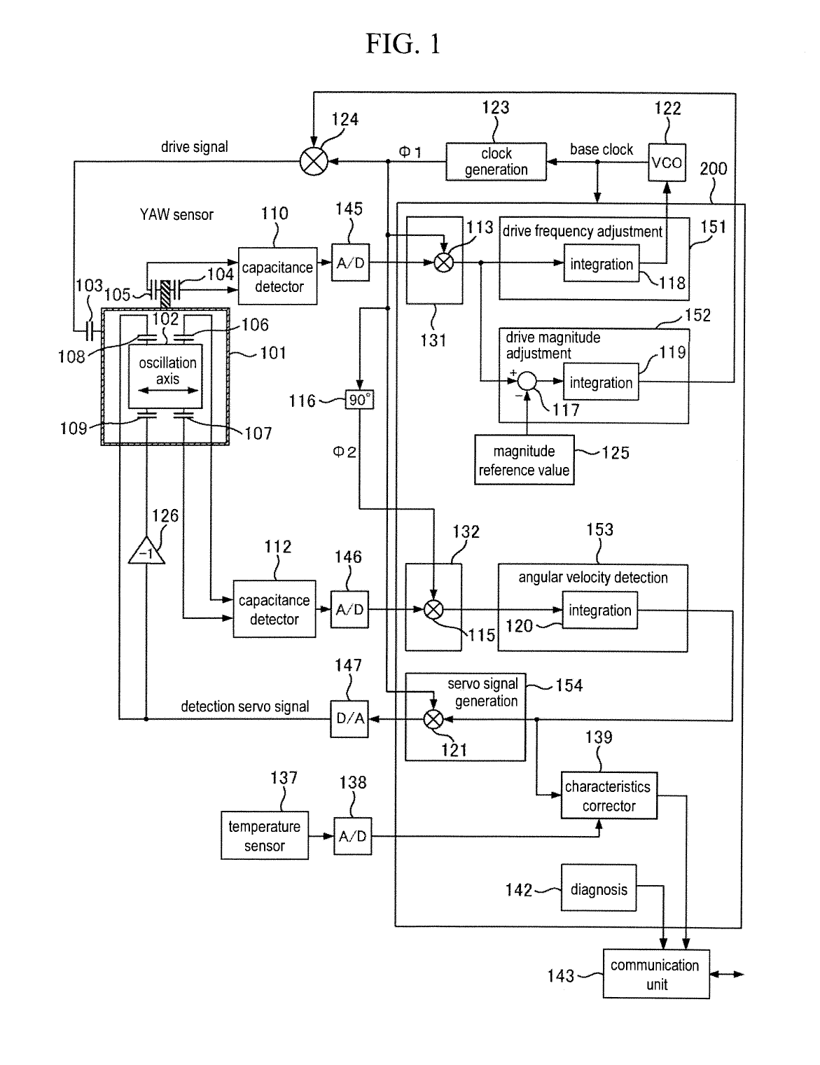

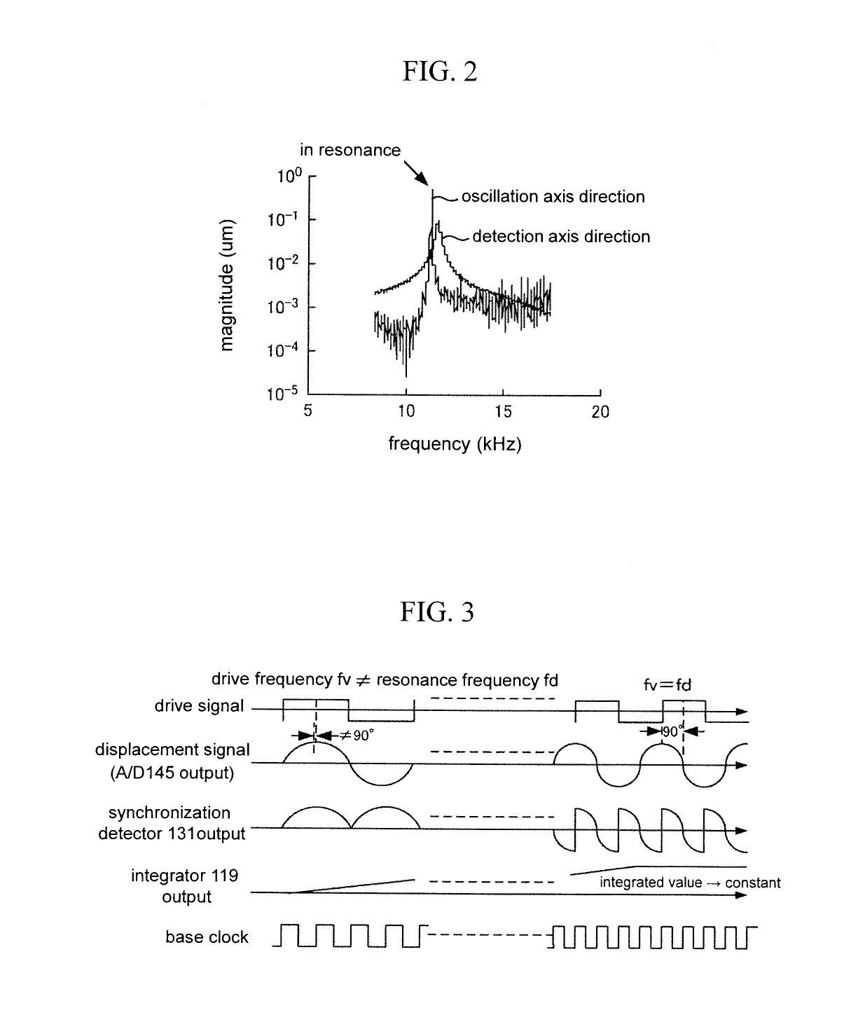

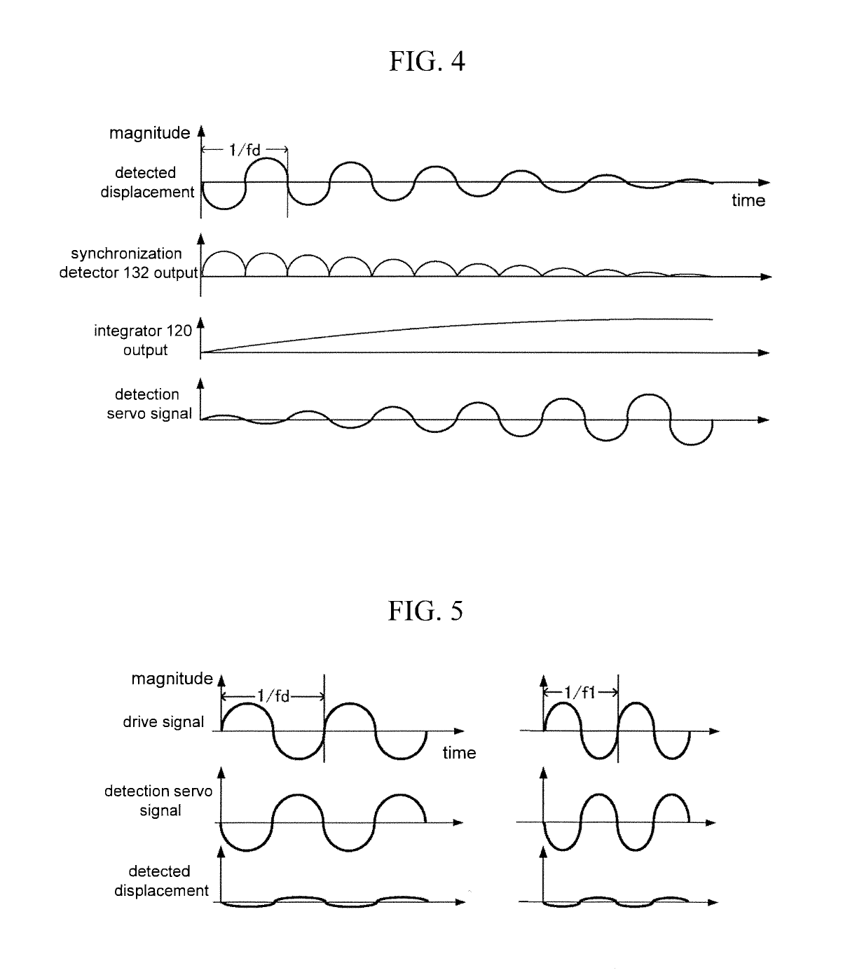

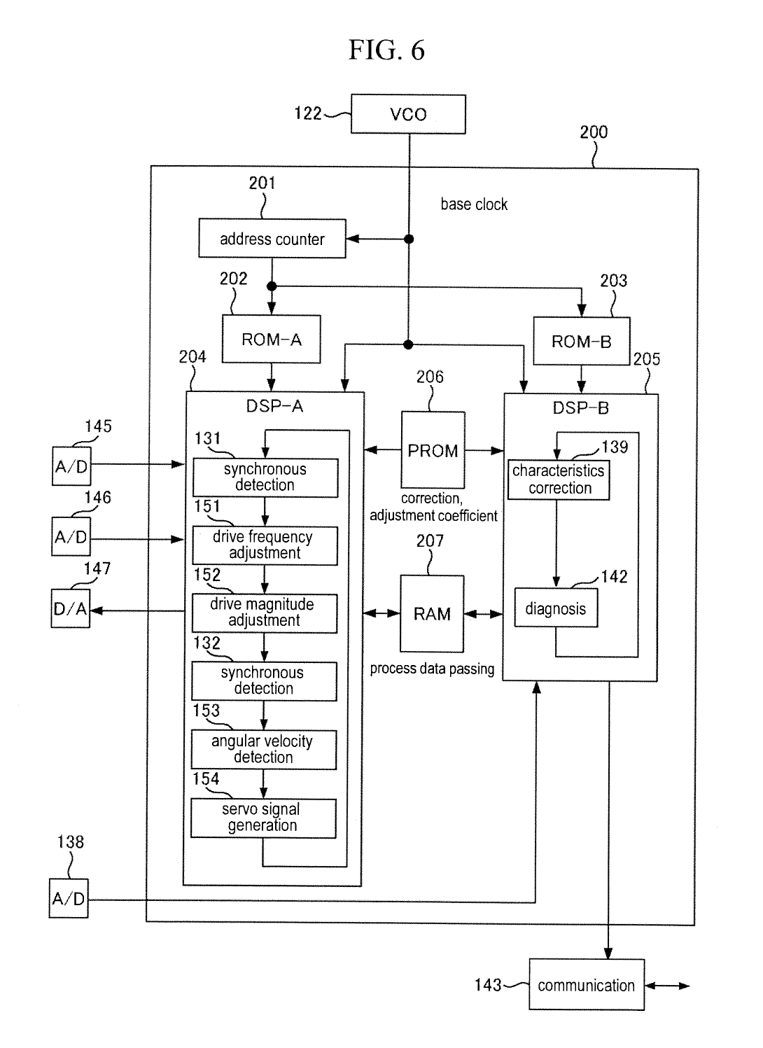

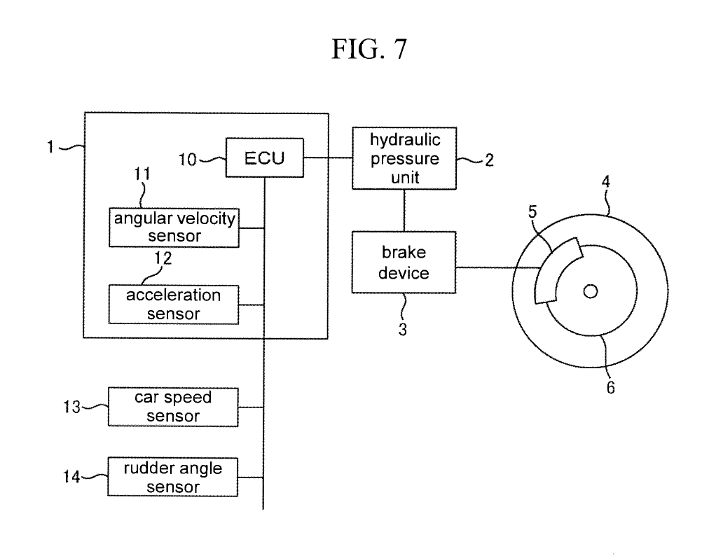

### BRIEF DESCRIPTION OF DRAWINGS

[FIG. 1] FIG. 1 is a block diagram of a sensor control circuit according to a first example.

[FIG. 2] FIG. 2 is a diagram showing a frequency-magnitude characteristic in an oscillation axis direction and in a detection axis direction.

[FIG. 3] FIG. 3 is a timing chart of a drive frequency adjustment unit of the first example.

[FIG. 4] FIG. 4 is a time chart showing a servo-control of the first example.

[FIG. 5] FIG. 5 is a time chart showing a change in frequency of a servo signal of the first example.

[FIG. 6] FIG. 6 is a block diagram of a control circuit of an angular velocity sensor using a digital signal processor of a second example.

[FIG. 7] FIG. 7 is a block diagram of an antiskid brake system of an example.

### DESCRIPTION OF EMBODIMENTS

Hereinafter, examples of the present invention will be described using FIGS. 1-7.

Firstly, a first example will be described using FIGS. 1-5.

An angular velocity detection element 101 of the present example comprises : an oscillator 102 that has a certain mass and that oscillates in an oscillation axis direction at an oscillation frequency (resonant frequency) fd; a fixed electrode (external force application means) 103 that exerts an electrostatic force for adjusting the oscillation magnitude and the oscillation frequency of the oscillator 102 in the oscillation direction; fixed electrodes (displacement detection means) 104 and 105 that detect the oscillation magnitude and the oscillation frequency of the oscillator 102 according to change in capacitance; fixed electrodes (displacement detection means) 106 and 107 that detect, according to change in capacitance, displacements of the oscillator 102 in the direction perpendicular to the oscillation axis caused by the Coriolis force due to application of angular velocity; and fixed electrodes (servo signal application means) 108 and 109 that exert electrostatic force to the oscillator 102 so that the Coriolis force to the oscillator 102 is canceled.

The angular velocity detection device further comprises: a capacitance detector 110 that detects displacements of the angular velocity detection element 101 in the oscillation direction by detecting the difference between the capacitance between the angular velocity detection element 101 and the fixed electrode 104 and the capacitance between the angular velocity detection element 101 and the fixed electrode 105; an AD convertor that converts the output from the capacitance detector 110 into digital signals; a synchronous detector 131 including a multiplier 113 that performs synchronous detection using a detection signal Φ1; and a drive frequency adjustment unit 151 including an integrator 118 that adds the output from the synchronous detector 131 at a constant interval.

The angular velocity detection device further comprises a drive magnitude adjustment unit 152 including: a subtractor 117 that calculates the difference between the output from the synchronous detector 131 and a preconfigured value in a magnitude reference value register 125; and an integrator 119 that adds the output from the subtractor 117 at a constant interval.

The angular velocity detection device further comprises: a capacitance detector 112 that detects displacements of the oscillator 102 due to the Coriolis force by detecting the difference between the capacitance between the oscillator 102 and the fixed electrode 106 and the capacitance between the oscillator 102 and the fixed electrode 107, and that converts the displacements into digital signals; an AD convertor 146 that converts the output from the capacitance detector 112 into digital signals; a multiplier 115 for performing synchronous detection using a detection signal Φ2 which phase is delayed by a phase adjuster 116 by 90 degree; and an angular velocity detection unit 153 including an integrator 120 that adds the output from the multiplier 115 at a constant interval.

The angular velocity detection device further comprises a servo signal generator 154 including a multiplier 121 that multiplies the output from the integrator 120 with the detection signal Φ1.

The angular velocity detection device further comprises: a VCO (voltage control oscillator) 122 that outputs a base clock in accordance with the output from the integrator 118; and a clock generator 123 that performs frequency division with respect to the output from the VCO 122 to output the drive signal and the detection signal Φ1.

The angular velocity detection device further comprises: a characteristics corrector 139 that corrects the output from the angular velocity sensor in accordance with the output from the temperature sensor 137; a diagnosis unit 142 that performs self-diagnosis with respect to each of the functions in the sensor; and a communication unit 143 that outputs the sensor output to external devices.

Next, the operation will be described. FIG. 2 shows frequency characteristics of the angular velocity detection element 101 in the oscillation axis direction and in the detection axis direction. FIG. 2 shows that the oscillation magnitude in the oscillation axis direction reaches the peak at the resonant frequency and decreases rapidly from the peak. FIG. 2 also shows that the magnitude becomes significantly small when driven at frequencies other than the resonant frequency and the magnitude in the detection axis direction also decreases simultaneously. The frequency of displacement oscillation in the detection axis direction due to generation of angular velocity matches with the oscillation frequency in the oscillation axis direction. Therefore, in order to increase the magnitude in the detection axis direction, it is necessary to constantly drive the oscillation axis direction at the resonant frequency.

For the reason stated above, the drive frequency adjustment unit 151 adjusts the frequency of the drive signal so that the oscillation of the oscillator 102 in the drive direction becomes resonated. The fixed electrodes 104 and 105 detect the displacement of the angular velocity detection element 101 due to the drive signal and then input the displacement into the capacitance detector 110. The synchronous detector 131 performs synchronous detection with respect to the displacement signal of the oscillator acquired through the capacitance detector 110 and the AD convertor 145 to detect the oscillation displacement in the oscillation axis direction. The integrator 118 integrates the signal acquired by the synchronous detector 131.

FIG. 3 shows a time chart of the drive frequency adjustment unit 151. The drive signal and the displacement signal have a characteristic that their phases are different from each other by 90 degree in resonant state, namely when fv (drive signal frequency)=fd (resonant frequency in the oscillation axis direction). Therefore, when performing synchronous detection with respect to the displacement signal using the detection signal Φ1, the drive signal and the displacement signal are resonated if the outputs of the synchronous detection are mutually canceled. At that time, the output from the integrator 118 converges into a constant value. The signal acquired by the integrator 118 is outputted into the VCO 122. The clock generator 123 generates the drive signal. As shown in the time chart of FIG. 3, the base clock outputted from the VCO is controlled so that its frequency is constantly an integer multiple of that of the drive signal.

Next, the drive magnitude adjustment unit 152 adjusts the magnitude of the drive signal so that the magnitude of the oscillation of the oscillator 102 in the drive direction matches with the value in the magnitude reference value register 125. The synchronous detector 131 performs synchronous detection with respect to the displacement signal of the oscillator acquired through the AD convertor 145 to detect the oscillation displacement in the oscillation axis direction. The subtractor 117 calculates the difference between the displacement and the target value and the integrator 119 integrates the difference. When the output from the synchronous detector 131 matches with the magnitude reference value register 125, the difference becomes zero. As a result, the output from the integrator 119 converges into a constant value. The signal acquired by the integrator 119 is outputted into the multiplier 124. The multiplier 124 multiplies the output from the clock generator 123 with the output from the drive magnitude adjustment unit 152 to generate the drive signal.

FIG. 4 shows a time chart of the servo control. The angular velocity detector 153 detects the displacement of the oscillator 102 in the detection axis direction (perpendicular to the oscillation axis) due to the Coriolis force using the fixed electrodes 106, 107 and the capacitance detector 112. The synchronous detector 132 performs synchronous detection with respect to the detected displacement signal of the oscillator acquired through the capacitance detector 112 and the AD convertor 146, thereby detecting the oscillation displacement perpendicular to the oscillation axis. The integrator 120 integrates the signal acquired by the synchronous detector 132. The servo signal generator 154 applies an electric voltage to the fixed electrodes 108 and 109 to cancel the displacement by the Coriolis force to the oscillator using the electrostatic force generated between the electrodes and the oscillator. Namely, a servo control is performed in which a signal is fed back to the sensor such that the displacement of the oscillator 102 due to the Coriolis force in the direction perpendicular to the oscillation axis becomes zero. Specifically, the multiplier 121 multiplies the Φ1 to generate a detection servo signal in order to feed back the signal acquired by the integrator 120 into the oscillator 102. The detection servo signal is applied to the fixed electrode 108 of the oscillator 102 and the inverted detection servo signal inverted by the polarity reverser 126 is applied to the fixed electrode 109, thereby canceling the detected displacement oscillation. The output from the integrator 120 when the displacement oscillation is canceled is outputted as the angular velocity detection signal.

FIG. 5 is a time chart of the servo signal generator 154. The detection servo signal is generated from the Φ1 outputted from the clock generator 123, similarly to the drive signal. Therefore, if the resonant frequency of the oscillator 102 is fd, the drive frequency adjustment unit 151 adjusts the frequency of the output Φ1 of the clock generator 123 as fd and the frequency of the drive signal becomes fd. When a displacement occurs due to angular velocity in this state, since the frequency of the displacement oscillation in the detection axis direction is fd, the detected displacement can be suppressed by feeding back the detection servo signal of frequency fd. On the other hand, the resonant frequency of the oscillator may be f1 due to manufacturing tolerance, or the resonant frequency fd at normal temperature may change into f1 due to increase of peripheral temperature. In such cases, the drive frequency adjustment unit 151 adjusts the frequency of the output Φ1 of the clock generator 123 as f1 and the frequency of the drive signal becomes f1. When a displacement occurs due to angular velocity in this state, since the frequency of the displacement oscillation in the detection axis direction is f1, the detected displacement can be suppressed by feeding back the detection servo signal of frequency f1.

The characteristics corrector 139 performs, with respect to the angular velocity output and the acceleration output in two directions, temperature correction and high-frequency noise reduction using a low-pass filter in accordance with the detection value of the temperature sensor 137. The diagnosis unit 142 performs diagnosis for driving function and angular velocity detecting function regarding angular velocity detection. The communication unit 143 sends, to external devices, the three sensor outputs in which the characteristics corrector 139 corrects the characteristics and the diagnosis result by the diagnosis unit 142.

As described above, the displacement oscillation of the oscillator in the detection axis direction can be suppressed with high precision by controlling the frequency of the servo signal so that it matches with the resonant frequency of the oscillator 102 constantly. Thus the angular velocity can constantly be detected with high precision even under influences of vibration or electromagnetic noise. Further, it is not necessary to adjust individual tolerances of resonant frequency of the detection element when shipping and the individual tolerances can be automatically adjusted.

Next, a second example will be described using FIG. 6.

The sensor control in this example is implemented using two DSPs (Digital Signal Processor), namely DSP-A 204 and DSP-B 205 and using control programs stored in two ROMs (Read Only Memory), namely ROM-A 202 and ROM-B 203. The VCO 122 is a means for generating clocks at a frequency of integer multiple of the resonant frequency of the angular velocity detection element 101 in the oscillation axis direction, as described in the example of FIG. 1. An address counter 201 is a counter that simply counts up according to the base clock inputted from the VCO 122.

The DSP-A 204 performs processes of the synchronous detector 131, the drive frequency adjustment unit 151, the drive magnitude adjustment unit 152, the angular velocity detector 153, and the servo signal generator 154 described in FIG. 1. The DSP-B 205 performs processes of the characteristics corrector 138 and the diagnosis unit 142. A PROM 207 is a memory storing coefficients of integration and coefficients of characteristics correction. A RAM 207 is a temporal storing buffer to pass the result calculated by the DSP-A 204 to the DSP-B 205.

Next, the operation will be described. The two DSPs, namely the DSP-A 204 and the DSP-B 205 operate in accordance with the base clock outputted from the VCO 122. The DSP-A 204 repeatedly performs, at the frequency four times as high as the resonant frequency, the processes from the synchronous detector 131 to the servo signal generator 154 stored from the 0-th address to the last address (e.g. 255-th address) of the ROM-A 202 as one cycle. The DSP-B 205 repeatedly performs, at the one-fourth frequency of the resonant frequency, the processes of the characteristics corrector 139 and the diagnosis unit 142 stored from the 0-th address to the last address (e.g. 4095-th address) of the ROM-B 203 as one cycle. Therefore, during the DSP-B 205 performs its one cycle process, the DSP-A 204 performs 16 cycles of its one cycle. The two ROMs, namely the ROM-A 202 and the ROM-B 203 are configured such that no effective address skipping occurs such as process branch of conditional judgment or subroutine call and such that the 0-th address to the last address are simply repeated. Therefore, as shown in the time chart of FIG. 2, when the resonant frequency changes the output from the VCO 122 follows the change. Thus the base clocks inputted into the DSP-A 204 and the DSP-B 205 change. Accordingly, the process repetition frequency of the DSP-A 204 is constantly kept as four times as high as the resonant frequency and the process repetition frequency of the DSP-B 205 is constantly kept as one-fourth of the resonant frequency. As a result, the servo signal outputted from the servo signal generator 154 can be controlled to constantly match with the resonant frequency of the oscillator 102 in the oscillation direction.

This achieves adjusting the frequency of the drive signal in the oscillation axis direction and the frequency of the servo signal in the detection axis direction so that they match with the resonant frequency in accordance with the change in the resonant frequency of the detection element. Thus the displacement oscillation in the detection axis direction caused at the same frequency as that of the oscillation in the oscillation axis direction can be suppressed, thereby achieving angular velocity detection with high precision even under influences of vibration or electromagnetic noise.

FIG. 7 is a system configuration example of an antiskid brake system equipping the present invention. A control unit 1 is a function that detects signs of skids or turnings of the running car using multiple sensors to control the brake of the car so that the skids or turnings are suppressed. An angular velocity sensor 11 is a sensor that detects angular velocities caused when turning of the running car occurs. An acceleration sensor 12 is a sensor that detects the velocity of the running car caused when skids of the running car occurs. A car speed sensor 13 is a sensor that detects the speed of the running car. A rudder angle sensor 14 is a sensor that detects the angle of the handle of the car. An ECU 10 is an engine control unit (hereinafter, referred to as ECU) that keeps the posture of the car according to the outputs from the above-mentioned multiple sensors. A hydraulic pressure unit 2 is a function that controls the brake pressure of the four wheels via hydraulic pressure in accordance with the control by the ECU 10. A brake device 3 is a function that applies brake force by the friction between a brake disc 6 and a brake pad 5 of a wheel 4 via hydraulic pressure. The above-mentioned system is placed near the engine of the car. Thus the operating environment is within high temperature from −40 Celsius degree to +125 Celsius degree. If the angular velocity sensor 11 is equipped in the control unit 1 along with the ECU 10, the resonant frequency of the detection element of the angular velocity sensor 11 fluctuates due to the wide range temperature variation. If the present invention is applied in the above-stated environment, the drive frequency and the frequency of the detection servo signal can be controlled to match with the fluctuated resonant frequency, thereby acquiring precise angular velocity outputs.

### REFERENCE SIGNS LIST

101: angular velocity detection element

102: oscillator

103: fixed electrode (external force application means)

104, 105, 106, 107: fixed electrode (displacement detection means)

108, 109: fixed electrode (servo signal application means)

110, 112: capacitance detector

113, 115, 121, 124: multiplier

116: phase adjuster

117: subtractor

118, 119, 120: integrator

122: VCO (Voltage Control Oscillator)

123: clock generator

125: magnitude reference value register

137: temperature sensor

138, 145, 146: AD converter

139: characteristics corrector

142: diagnosis unit

143: communication unit

147: DA converter

151: drive frequency adjustment unit

152: drive magnitude adjustment unit

153: angular velocity detector

154: servo signal generator

201: address counter

202: ROM-A

203: ROM-B

204: DSP-A

205: DSP-B

206: PROM

207: RAM

301, 302, 303, 304: register

1. An angular velocity detection device comprising an oscillating body displaceable in a first and a second direction perpendicular to each other,
the angular velocity detection device detecting, as an angular velocity, a displacement of the oscillating body in the second direction when the oscillating body is oscillating in the first direction,
wherein the angular velocity detection device changes a frequency of a servo signal for detecting an angular velocity based on a displacement amount of the oscillating body in the second direction in accordance with a change in frequency of a drive signal that oscillates the oscillating body in the first direction.

2. The angular velocity detection device according to claim 1, wherein
the frequency of the servo signal is the same as that of means for oscillating the oscillating body in the first direction.

3. The angular velocity detection device according to claim 1, wherein
the frequency of the servo signal is the same as that of a resonant frequency in the first direction.

4. The angular velocity detection device according to claim 1, wherein
an operating frequency of means for generating the servo signal is an integer multiple of an oscillating frequency in the first direction.

5. An antiskid brake system in which the angular velocity detection device according to claim 1 is placed on a substrate on which an engine control unit is provided.

6. The angular velocity detection device according to claim 1, wherein
an operation of the angular velocity detection device is guaranteed within a temperature range from −40 Celsius degree to +125 Celsius degree.

7. An angular velocity detection device comprising:
an oscillating body displaceable in a first and a second direction perpendicular to each other;
means for detecting, as a change in capacitance, a displacement amount of the oscillating body in the second direction due to generation of angular velocity when the oscillating body is oscillating in the first direction;
means for converting the change in capacitance into digital information;
means for adjusting, according to the digital information, a frequency of a drive signal that oscillates the oscillating body in the first direction;
means for adjusting a magnitude of the drive signal that oscillates the oscillating body in the first direction;
means for outputting a servo signal that works so that a displacement of the oscillating body in the second direction is suppressed; and
means for changing a frequency of the servo signal in accordance with an output from the means for adjusting the frequency of the drive signal.

8. An antiskid brake system that is mounted on a substrate on which the angular velocity detection device according to claim 7 is provided.

9. The angular velocity detection device according to claim 7, wherein
an operation of the angular velocity detection device is guaranteed within a temperature range from −40 Celsius degree to +125 Celsius degree.
